(19) United States
(12) Patent Application Publication
(10) Pub. No.: US 2007/0190984 A1
(43) Pub. Date: Aug. 16, 2007

(54) INSTANT MESSAGING INTERWORKING IN AN ADVANCED VOICE SERVICES (AVS) FRAMEWORK FOR WIRELESS COMMUNICATIONS SYSTEMS

(76) Inventors: Ravi Ayyasamy, Richardson, TX (US); Bruce D. Lawler, San Jose, CA (US); Krishnakant M. Patel, Dallas, TX (US); Vyankatesh V. Shanbhag, Plano, TX (US); Brahmananda R. Vempati, Dallas, TX (US); Ravi Shankar Kumar, Plano, TX (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/567,098

(22) Filed: Dec. 5, 2006

Related U.S. Application Data
(60) Provisional application No. 60/742,250, filed on Dec. 5, 2005.

(51) Int. Cl. H04Q 7/38

(52) U.S. Cl. 455/414.1; 455/466

(57) ABSTRACT

A real-time exchange (RTX) interfaces to a wireless communications system to provide enhanced features for advanced voice services (AVS), which include instant messaging interworking.

### CROSS REFERENCE TO RELATED APPLICATIONS

This application claims the benefit under 35 U.S.C. Section 119(e) of the following co-pending and commonly-assigned U.S. provisional patent application:

Ser. No. 60/742,250, filed on Dec. 5, 2005, by Ravi Ayyasamy, Bruce D. Lawler, Krishnakant M. Patel, Vyankatesh V. Shanbhag and Brahmananda R. Vempati, entitled “INSTANT MESSAGING INTERWORKING,” attorneys' docket number 154.23-US-P1;

which application is incorporated by reference herein.

This application is related to the following co-pending and commonly-assigned patent applications:

U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,” attorney docket number G&C 154.4-US-WO, which application claims the benefit under 35 U.S.C. Section 365 of PCT International Patent Application Serial Number PCT/US03/16386 (154.4-WO-U1), which application claims the benefit under 35 U.S.C. Section 119(e) of U.S. Provisional Patent Application Ser. Nos. 60/382,981 (154.3-US-P1), 60/383,179 (154.4-US-P1) and 60/407,168 (154.5-US-P1);

U.S. Utility Application Ser. No. 10/564,903, filed Jan. 17, 2006, by F. Craig Farrill, Bruce D. Lawler and Krishnakant M. Patel, entitled “PREMIUM VOICE SERVICES FOR WIRELESS COMMUNICATIONS SYSTEMS,” attorney docket number G&C 154.7-US-WO, which application claims the benefit under 35 U.S.C. Section 365 of PCT International Patent Application Serial Number PCT/US04/23038 (154.7-WO-U1), which application claims the benefit under 35 U.S.C. Section 119(e) of U.S. Provisional Patent Application Ser. Nos. 60/488,638 (154.7-US-P1), 60/492,650 (154.8-US-P1) and 60/576,094 (154.14-US-P1) and which application is a continuation-in-part and claims the benefit under 35 U.S.C. Section 119, 120 and/or 365 of PCT International Patent Application Serial Number PCT/US03/16386 (154.4-WO-U1);

U.S. patent application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS MS 120 AND NETWORKS,” attorney docket number 154.9-US-U1, which application claims the benefit under 35 U.S.C. Section 119(e) of U.S. Provisional Patent Application Ser. Nos. 60/569,953 (154.9-US-P1) and 60/579,309 (154.15-US-P1), and which application is a continuation-in-part and claims the benefit under 35 U.S.C. Sections 119, 120 and/or 365 of U.S. Utility patent application Ser. No. 10/515,556 (154.4-US-WO) and PCT International Patent Application Serial Number PCT/US04/23038 (154.7-WO-U1);

U.S. Utility patent application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” attorney docket number 154.10-US-U1, which application claims the benefit under 35 U.S.C. Section 119(e) of U.S. Provisional Patent Application Ser. No. 60/571,075 (154.10-US-P1), and which application is a continuation-in-part and claims the benefit under 35 U.S.C. Sections 119, 120 and/or 365 of U.S. Utility patent application Ser. No. 10/515,556 (154.4-US-WO) and P.C.T. International Patent Application Serial Number PCT/US04/23038 (154.7-WO-U1);

U.S. Utility patent application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” attorney docket number 154.11-US-U1, which application claims the benefit under 35 U.S.C. Section 119(e) of U.S. Provisional Patent Application Ser. Nos. 60/573,059 (154.11-US-P1) and 60/576,092 (154.12-US-P1), and which application is a continuation-in-part and claims the benefit under 35 U.S.C. Sections 119, 120 and/or 365 of U.S. Utility patent application Ser. No. 10/515,556 (154.4-US-WO), P.C.T. International Patent Application Serial Number PCT/US04/23038 (154.7-WO-U1), U.S. Utility patent application Ser. No. 11/126,587 (154.9-US-U1), and U.S. Utility patent application Ser. No. 11/129,268 (154.10-US-U1);

U.S. Utility patent application Ser. No. 11/136,233, filed May 24, 2005, by Krishnakant M. Patel, Vyankatesh Vasant Shanbhag, and Anand Narayanan, entitled “SUBSCRIBER INFORMATION MODULE (SIM) ENABLING ADVANCED VOICE SERVICES (AVS) INCLUDING PUSH TO TALK ON WIRELESS MS 120 AND NETWORKS,” attorney docket number 154.13-US-U1, which application claims the benefit under 35 U.S.C. Section 119(e) of U.S. Provisional Patent Application Ser. No. 60/573,780 (154.13-US-P1), and which application is a continuation-in-part and claims the benefit under 35 U.S.C. Sections 119, 120 and/or 365 of U.S. Utility patent application Ser. No. 10/515,556 (154.4-US-WO), P.C.T. International Patent Application Serial Number PCT/US04/23038 (154.7-WO-U1), U.S. Utility patent application Ser. No. 11/126,587 (154.9-US-U1), and U.S. Utility patent application Ser. No. 11/134,883 (154.11-US-U1);

U.S. Utility patent application Ser. No. 11/158,527, filed Jun. 22, 2005, by F. Craig Farrill, entitled “PRESS-TO-CONNECT FOR WIRELESS COMMUNICATIONS SYSTEMS,” attorney docket number 154.16-US-U1, which application claims the benefit under 35 U.S.C. Section 119(e) of U.S. Provisional Patent Application Ser. No. 60/581,954 (154.16-US-P1), and which application is a continuation-in-part and claims the benefit under 35 U.S.C. Sections 119, 120 and/or 365 of U.S. Utility patent application Ser. No. 10/515,556 (154.4-US-WO) and P.C.T. International Patent Application Serial Number PCT/US04/23038 (154.7-WO-U1);

U.S. Utility patent application Ser. No. 11/183,516, filed Jul. 18, 2005, by Deepankar Biswaas, entitled “VIRTUAL PUSH TO TALK (PTT) AND PUSH TO SHARE (PTS) FOR WIRELESS COMMUNICATIONS SYSTEMS,” attorney docket number 154.17-US-U1, which application claims the benefit under 35 U.S.C. Section 119(e) of U.S. Provisional Patent Application Ser. No. 60/588,464 (154.17-US-P1);

U.S. Utility patent application Ser. No. 11/356,775, filed Feb. 17, 2006, by Krishnakant M. Patel, Bruce D. Lawler, Giridhar K. Boray, and Brahmananda R. Vempati, entitled “ENHANCED FEATURES IN AN ADVANCED VOICE SERVICES (AVS) FRAMEWORK FOR WIRELESS COMMUNICATIONS SYSTEMS,” attorney docket number 154.18-US-U1, which application claims the benefit under 35 U.S.C. Section 119(e) of U.S. Provisional Patent Application Ser. No. 60/654,271 (154.18-US-P1);

PCT International Patent Application Serial Number PCT/US2006/011628, filed Mar. 30, 2006, by Krishnakant M. Patel, Gorachand Kundu, Sameer Dharangaonkar, Giridhar K. Boray, and Deepankar Biswas, entitled “TECHNIQUE FOR IMPLEMENTING ADVANCED VOICE SERVICES USING AN UNSTRUCTURED SUPPLEMENTARY SERVICE DATA (USSD) INTERFACE,” attorney docket number 154.19-WO-U1, which application claims the benefit under 35 U.S.C. Section 119(e) of U.S. Provisional Patent Application Ser. No. 60/666,424 (154.19-US-P1);

U.S. Utility patent application Ser. No. 11/462,332, filed Aug. 3, 2006, by Deepankar Biswas, Krishnakant M. Patel, Giridhar K. Boray, and Gorachand Kundu, entitled “ARCHITECTURE AND IMPLEMENTATION OF CLOSED USER GROUP AND LIMITING MOBILITY IN WIRELESS NETWORKS,” attorney docket number 154.20-US-U1, which application claims the benefit under 35 U.S.C. Section 119(e) of U.S. Provisional Patent Application Ser. No. 60/705,115 (154.20-US-P1); and

U.S. Utility patent application Ser. No. 11/463,186, filed Aug. 8, 2006, by Ravi Ayyasamy and Krishnakant M. Patel, entitled “ADVANCED VOICE SERVICES CLIENT FOR BREW PLATFORM,” attorney docket number 154.21-US-U1, which application claims the benefit under 35 U.S.C. Section 119(e) of U.S. Provisional Patent Application Ser. No. 60/706,265 (154.21-US-P1);

all of which applications are incorporated by reference herein.

### BACKGROUND OF THE INVENTION

1. Field of the Invention

This invention relates in general to wireless communications systems, and more specifically, to enhanced features for advanced voice services wireless communications systems.

2. Description of Related Art

Advanced voice services (AVS), such as two-way half-duplex voice calls within a group, also known as Push-to-Talk (PTT) or Press-to-Talk (P2T), as well as other AVS functions, such as Push-to-Conference (P2C) or Instant Conferencing, Upgrade to Conference, Push-to-Message (P2M), etc., are described in the co-pending and commonly-assigned patent applications cross-referenced above and incorporated by reference herein. These AVS functions have enormous revenue earnings potential for wireless communications systems, such as cellular networks and personal communications systems (PCS) networks.

Currently, there are three major approaches employed in providing advanced voice services in wireless communications systems. One approach requires the installation of a dedicated private network, parallel to the wireless communications system, to support the group-based voice services. NEXTEL uses such a system, based on a solution developed by MOTOROLA known as IDEN. However, a dedicated private network is costly to install and maintain and is employed by a few public wireless carriers. Also, the IDEN system is non-standard, and hence cannot be used in standard wireless communications networks, such as those based on GSM (Global System for Mobile Communications) and CDMA (Code Division Multiple Access).

Another approach is based on Voice over IP (VoIP) technologies. While this approach promises compliance with newer and emerging standards, such as GPRS (General Packet Radio Service), UMTS (Universal Mobile Telecommunications System), etc., it does not provide a solution for carriers employing wireless communications systems based on existing standards, such as GSM, CDMA, etc. However, even for the newer standards, solutions based on VoIP have serious drawbacks, including slower call setup, significant overhead, increased susceptibility to packet losses, low bit rate voice coders, and significant modifications to the mobile handset. There is a need, instead, for solutions that require only minimal upgrades to the handset.

Still another approach is that defined in the co-pending and commonly-assigned patent applications cross-referenced above and incorporated by reference herein. In this approach, advanced voice services are provided by a dispatch gateway (DG) or real-time exchange (RTX) that interfaces to the wireless communications system to provide the advanced voice services therein, wherein both the dispatch gateway and mobiles that use the advanced voice services communicate with each other using call setup and in-band signaling within the wireless communications system.

Notwithstanding these innovations, there is a need in the art for other advanced voice services that comply with existing and emerging wireless standards and provide superior user experiences. The present invention aims to satisfy this need by providing enhanced features in advanced voice services for wireless communications systems.

### SUMMARY OF THE INVENTION

To overcome the limitations in the prior art described above, and to overcome other limitations that will become apparent upon reading and understanding the present specification, the present invention discloses enhanced features for advanced voice services for wireless communications systems. A real-time exchange (RTX) interfaces to the wireless communications system to provide these enhanced features for the advanced voice services, which include instant messaging interworking.

### BRIEF DESCRIPTION OF THE DRAWINGS

Referring now to the drawings in which like reference numbers represent corresponding parts throughout:

FIG. 1 is a block diagram that illustrates an exemplary embodiment of the dispatch services architecture framework according to a preferred embodiment of the present invention;

FIG. 2 is a block diagram that illustrates the architecture of the real-time exchange according to the preferred embodiment of the present invention; and

FIG. 3 is a block diagram that illustrates the instant messaging interworking performed for instant messaging services according to the preferred embodiment of the present invention.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

Overview

The present invention comprises an advanced voice service (AVS) for wireless communications systems. Specifically, the AVS comprises instant messaging (IM) interworking capabilities between a wireless network and an internet protocol (IP) network. This AVS functionality includes server and handset functionality, as well as presence, contact management, and voice and/or IM session management.

Network Architecture

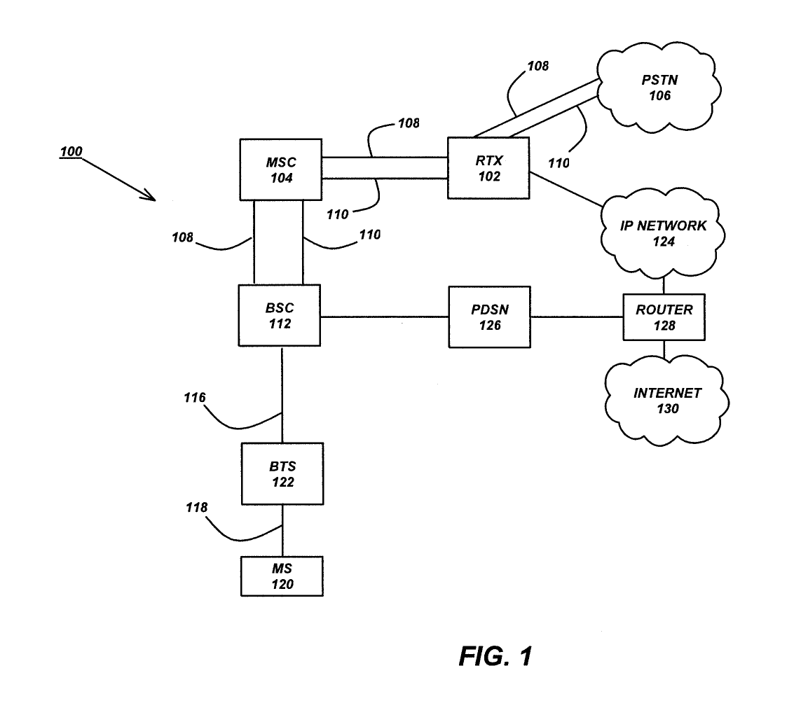

FIG. 1 is a block diagram that illustrates an exemplary embodiment of a wireless communications network 100 according to a preferred embodiment of the present invention.

Within the network 100, an RTX (Real-Time Exchange) 102, previously known as a Dispatch Gateway (DG), communicates with a MSC (Mobile Switching Center) 104 and PSTN (Public Switched Telephone Network) 106 using SS7—ISUP/WIN/CAMEL (Signaling System 7—Integrated Services Digital Network User Part/Wireless Intelligent Network/Customized Applications for Mobile Enhanced Logic) messages at a signaling plane 108. A bearer path 110 implements a TDM (Time Division Multiplexing) interface carrying PCM (Pulse Code Modulation) or TFO (Tandem Free Operation) voice frames. Support for TFO in this path 110 is negotiated between a BSC (Base Station Controller) 112 and the RTX 102 for each originating and terminating leg of an AVS call. The use of TFO ensures high voice quality (as voice vocoder conversion is avoided) between mobile-to-mobile calls.

When a subscriber originates an AVS call, the MSC 104 routes the call to the RTX 102. The MSC 104 also requests the BSC 112 via 116 to establish a radio traffic path 118 with a mobile station (MS) 120 (also known as a handset or mobile unit) via the BTS (Base Transceiver Station) 122 (as it does for a normal cellular call). At this time, the BSC 112 tries to negotiate TFO (if it is supported) on a TDM link with the far end (in this case, the RTX 102).

At the same time (after the MSC 104 terminates the group call request to the RTX 102), the RTX 102 identifies the terminating group users and their MS-ISDN (Mobile Station-Integrated Services Digital Network) numbers. It sends an ISUP call origination request for each terminating MS 120. It may send requests directly to the MSC 104, PSTN 106 or IP network 124 via a PDSN (Public Data Switched Network) 126, Router 128, and/or Internet/Intranet 130, depending on the routing table configuration for terminating MS-ISDN numbers. Once the bearer path 110 is established, the RTX 102 begins a negotiation with the far end (in this case, the terminating BSC 112) for each terminating leg to a MS 120.

Once bearer paths 110 are established for originating and terminating legs for an AVS call, the RTX 102 switches (or duplicates) voice frames from the originating MS 120 to all terminating MS's 120.

The RTX 102 may use an IP network 124 or the Internet/Intranet 130 for two different purposes. The IP network 124 or the Internet/Intranet 130 can be used in a toll bypass mode where two RTXs 102 can exchange voice traffic bypassing the PSTN 106. However, each RTX 102 is responsible for terminating traffic to its closest MSC 104. In this case, the IP network 124 or the Internet/Intranet 130 is used as a backbone transport of voice traffic between two RTXs 102.

The IP network 124 or the Internet/Intranet 130 can also be used for a registration and presence application. Since the MSC 104 will not direct a registration request from a MS 120 to the RTX 102 (because it would require changes in the MSC 104), the latter does not have any information of the registered MS 120. To circumvent this issue, a registration and presence application runs over an IP stack in the MS 120. After the MS 120 registers for a data interface (i.e., obtaining an IP address) with the PDSN 126 (or Serving GSM Service Nodes (SGSN) in the case of GSM networks), the registration and presence application in the MS 120 registers with the RTX 102 using its IP address. The RTX 102 also uses this IP interface to update the presence information of other group members to a MS 120.

An alternative embodiment would use the SMS (Short Message Service) transport to carry presence messages over a data channel. The RTX 102 interacts with the MS 120 using predefined presence application related messages that are transported as SMS messages. The same messages can be transported via the PDSN 126 interface, if group users have data service.

Real Time Exchange

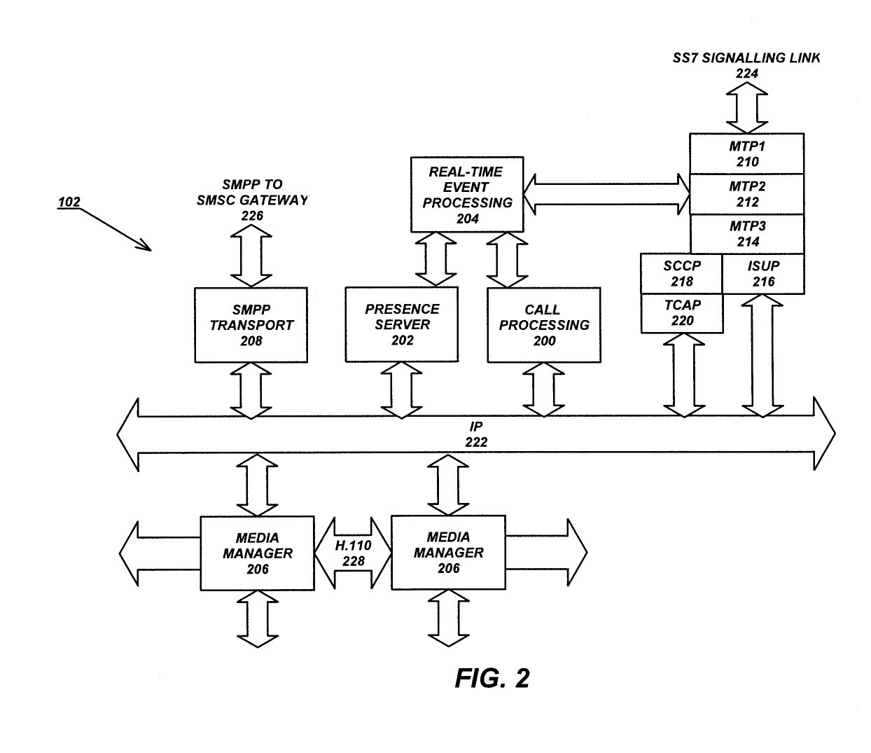

FIG. 2 illustrates a proposed architecture for the RTX 102 according to the preferred embodiment of the present invention.

The architecture includes a Call Processing system 200, Presence Server 202, Real-Time Event Processing system 204, one or more Media Managers 206, and an SMPP (Short Message Peer-to-Peer) Transport 208, as well as modules for various SS7 protocols, such as MTP-1 (Message Transfer Part Level 1) 210, MTP-2 (Message Transfer Part Level 2) 212, MTP-3 (Message Transfer Part Level 3) 214, ISUP (Integrated Services Digital Network User Part) 216, SCCP (Signaling Connection Control Part) 218, and TCAP (Transactions Capabilities Application Part) 220 protocols.

The Call Processing system 200, Presence Server 202, Media Managers 204, SMPP Transport 206, and other modules communicate across an IP network 222. The Real-Time Event Processing system 204 communicates directly with the Call Processing system 200, Presence Server 202, and the modules for various SS7 protocols. The modules for various SS7 protocols communicate with other entities via a SS7 Signaling Link 224. The SMPP Transport 206 communicates with a SMSC (Short Message Service Center) gateway using the SMPP protocol 226. The Media Managers 204 communicate among themselves using the H.110 protocol 228 (or some other protocol, such TCP/IP).

The operation of these various components are described in more detail below, as well as in the co-pending and commonly-assigned patent applications cross-referenced above and incorporated by reference herein.

The originating MS 120 signals the RTX 102 via the wireless network 100, e.g., by transmitting one or more configured DTMF (Dual Tone Multi Frequency) digits to the RTX 102. The Media Manager systems 206 receive the DTMF digits and pass the DTMF digits to the Call Processing system 200. The Call Processing (CP) system 200 determines whether the originating MS 120 has subscribed to the AVS feature before originating the AVS session. Upon confirmation, the Call Processing system 200 initiates a new AVS session. The Call Processing system 200 interacts with the Presence Server 202 and Real-Time Event Processing system 204 to cause the wireless network 100 to perform session setup for the AVS session, and thereafter to manage the AVS session.

During the AVS session, for example, the Call Processing system 200 interacts with the Media Manager systems 206 to maintain the H.110 channels 227 and assign any additional H.110 channels 228 required for the AVS session, which may span across multiple Media Manager systems 206. Moreover, the Media Manager systems 206 of the RTX 102 may be used, for example, to mix audio streams between the originating MS 120 and the terminating MS 120, and then deliver these mixed audio streams to the originating MS 120 and the terminating MS 120. The H.110 channels 228 are used for passing mixed and unmixed audio streams voice between the Media Manager systems 200 as required.

Instant Messaging Interworking

In one embodiment, the enhanced features comprise instant messaging (IM) interworking capabilities. IM differs from e-mail in that message exchange occurs in realtime or near realtime. Deployment of IM systems that support voice and text instant messages, such as AIM, MSN, Yahoo and Google, is rapidly gaining ground. The community of users served by such IM clients is rapidly increasing in size.

Interworking AVS users with this community enables a huge population of mobile users to interact with the IM systems. Interworking also allows the IM users to be unwired from their computers or laptops while allowing them to remain part of the IM community.

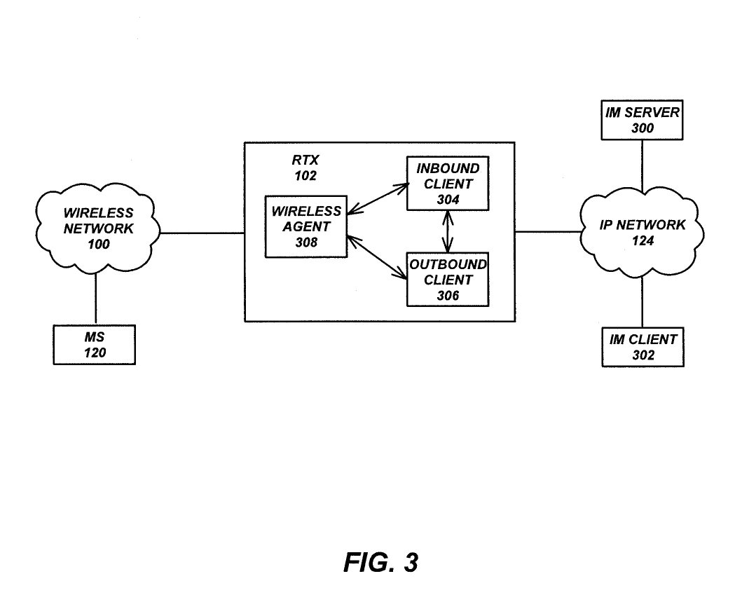

As shown in FIG. 3, the RTX 102 leverages one or more of the existing IM systems available on the Internet. In one embodiment, the RTX 102 interfaces to one or more IM servers 300, which in turn communicates with one or more IM clients 302. Upon request, the RTX 102 routes instant messages in real-time from the IM server 300 to the MS 120. IM also requires the use of a client program on the MS 120 that communicates with the IM server 300.

In this scenario, the RTX 102 includes an inbound client 304 for handling instant messages inbound from the IM server 300, an outbound client 306 for handling instant messages outbound to the IM server 300, and a wireless agent 308 for communicating the instant messages between the RTX 102 and the MS 120.

These inbound and outbound clients 304, 306 in the RTX 102 are proxy clients that act on behalf of the MS 120 and interwork with the IM server 300. In turn, the RTX 102 performs presence management, contact management, and IM session management for the MS 120. For example, the RTX 102 offers a presence feature, indicating whether people on one's list of contacts are currently online and available to chat.

The MS 120 indicates to the RTX 102 that the user is “mobile” and the user conducts presence management, contact management, and IM session management tasks using the client interface on the MS 120. In turn, the RTX 102 interworks presence management, contact management, and IM session management with the IM server 300 using the necessary protocols. The IM server 300 is oblivious to the access mode of the IM user, since the RTX 102 has insulated all access specific aspects from the IM server 300.

Note that such interworking between the MS 120 user and the IM client 302 user can extend to push-to-talk, voice conferencing (i.e., voice bridge), as well as voice notes. Moreover, interworking can also extend the community of AVS users by including users of IM clients 302, other MS 120 users (not subscribed to the AVS), and even landline users in a session originated by a user of the MS 120, wherein the RTX 102 serves as a bridge for such sessions.

### CONCLUSION

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing enhanced features for advanced voice services in a wireless network, comprising:
a wireless communications network for making calls to and from mobile units, wherein the calls are initiated by call setup and in-band signaling within the wireless communications network and voice frames for the calls are switched between the mobile units across bearer paths in the wireless communications network; and
a real-time exchange that interfaces to the wireless communications network to provide advanced voice services therein;
wherein the real-time exchange interfaces to one or more instant messaging servers, and upon request, routes instant messages between the instant messaging servers and the mobile units.

2. The apparatus of claim 1, wherein the instant messaging servers route instant messages between the real-time exchange and instant messaging clients.

3. The apparatus of claim 1, wherein the real-time exchange includes an inbound client for handling instant messages inbound from the instant messaging server.

4. The apparatus of claim 1, wherein the real-time exchange includes an outbound client for handling instant messages outbound to the instant messaging server.

5. The apparatus of claim 1, wherein the real-time exchange includes a wireless agent for communicating the instant messages between the real-time exchange and the mobile units.

6. The apparatus of claim 1, wherein the real-time exchange performs presence management, contact management, and session management for the mobile units.

7. A method of providing enhanced features for advanced voice services in a wireless network, comprising:
communicating with a wireless communications network to make calls to and from mobile units, wherein the calls are initiated by call setup and in-band signaling within the wireless communications network and voice frames for the calls are switched between the mobile units across bearer paths in the wireless communications network; and
interfacing a real-time exchange to the wireless communications network to provide the advanced voice services therein;
wherein the real-time exchange interfaces to one or more instant messaging servers, and upon request, routes instant messages between the instant messaging servers and the mobile units.

8. The method of claim 7, wherein the instant messaging servers route instant messages between the real-time exchange and instant messaging clients.

9. The method of claim 7, wherein the real-time exchange includes an inbound client for handling instant messages inbound from the instant messaging server.

10. The method of claim 7, wherein the real-time exchange includes an outbound client for handling instant messages outbound to the instant messaging server.

11. The method of claim 7, wherein the real-time exchange includes a wireless agent for communicating the instant messages between the real-time exchange and the mobile units.

12. The method of claim 7, wherein the real-time exchange performs presence management, contact management, and session management for the mobile units.
